(19) United States
(12) Patent Application Publication
(10) Pub. No.: US 2012/0104979 A1
(43) Pub. Date: May 3, 2012

(54) Phase change pulse engine

(76) Inventor: Chauncey Bigelow Sayre, Huntington Beach, CA (US)

(21) Appl. No.: 13/152,503

(22) Filed: Jun. 3, 2011

Related U.S. Application Data
(60) Provisional application No. 61/314,176, filed on Jun. 4, 2010.

(51) Int. Cl. H02K 33/16

(52) U.S. Cl. 318/130

(57) ABSTRACT

A phase change pulse engine includes a superconducting magnet and a control circuit including a power supply and a capacitor. A changing magnetic field creates a magnetic coupling for a mechanical drive. The capacitor is connected to the power supply and the magnet's coil through a switching and timing control circuit to initially charge the capacitor. With the coil isolated from the capacitor, electric current from the capacitor is discharged through the coil to create the magnetic coupling. After a predetermined period of time, an electrical connection is re-established between the capacitor and the coil to recharge the capacitor. This generates a pulse of electrical energy that is periodically applied to the coil with the capacitor isolated from the coil. The pulse of electrical energy includes make up energy due to capacitor losses.

### RELATED PATENT APPLICATION & INCORPORATION BY REFERENCE

This application claims the benefit under 35 USC 119(e) of U. S. Provisional Patent Application No. 61/314,176, entitled “Phase Change Pulse Engine,” filed Jun. 4, 2010. This related application is incorporated herein by reference and made a part of this application. If any conflict arises between the disclosure of the invention in this utility application and that in the related provisional application, the disclosure in this utility application shall govern. Moreover, any and all U. S. patents, U. S. patent applications, and other documents, hard copy or electronic, cited or referred to in this application are incorporated herein by reference and made a part of this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The words “substantially” and “essentially” have equivalent meanings.

The word “core” includes the empty space enclosed by a coiled superconducting wire.

### BACKGROUND

I have invented a phase change pulse engine using supper conductors as a means for making an engine that is very efficient. A suitable supper conductor that may be used in my engine is a metal or metal alloy such as, for example, alloys of the metals Nb and Sn and Nb and Ti. The super conductor in the form of a wire is coiled about a core. The coiled wire-core assembly is within a container for a cooling liquid that keeps the wire at a supercooling temperature that enables current to flow through the wire with no or virtually no resistance. Typically this temperature is equal to or less than 135 degrees Kelvin, and as better super conducting material is developed, this threshold temperature will increase. The core may comprise a magnetic material such as, for example, iron. This background discussion is not intended to be an admission of prior art.

### SUMMARY

My phase change pulse engine has one or more of the features depicted in the embodiments discussed in the section entitled “DETAILED DESCRIPTION OF SOME ILLUSTRATIVE EMBODIMENTS.” The claims that follow define my phase change pulse engine, distinguishing it from the prior art; however, without limiting the scope of my phase change pulse engine as expressed by these claims, in general terms, some, but not necessarily all, of its features are:

One, my phase change pulse engine includes a superconducting magnet electrically connected to a control circuit for generating a fluctuating or rapidly changing magnetic field in the magnet that creates a magnetic coupling for a mechanical drive. The superconducting magnet includes a coil and a core capable of being magnetized. Electric current flows through the coil to create the magnetic field. Increasing or decreasing current flow with the polarity remaining constant causes the intensity of the magnetic field to increase or decrease. Or, discontinuing or reversing the direction of current flow through the coil creates a fluctuating or rapidly changing magnetic field. Reversing the direction of current flow changes the polarity of the magnet.

Two, the control circuit includes one or more capacitors having predetermined capacitance and a power supply, for example, a DC power supply. The capacitor or capacitors are connected to the power supply and the magnet's coil through a switching and timing control circuit. This switching and timing control circuit governs the interaction between the capacitor or capacitors, coil, and power supply. With the switching and timing control circuit in a first state, current flows through the coil and into at least one capacitor. With the switching and timing control circuit in a second state, the one capacitor is disconnected from the coil. With the switching and timing control circuit in a third state, the one capacitor is reconnected to the coil and current again flows through the coil and again into the capacitor. The capacitor is thus momentarily disconnected from the coil, electrically isolating the coil from the capacitor, so the magnet field collapses at least partially to create the fluctuating or rapidly changing magnetic field in the magnet. The switching and timing control circuit may change the direction of flow of electric current through the coil to reverse the polarity of the magnet. The capacitor is then discharged and reconnected to the coil so the energy stored in the capacitor is redirected back into the coil. This cycle of charging the capacitor, disconnecting it from the coil, and then reconnecting to the coil is continually repeated, changing the magnetic field to pulse drive my engine.

Three, the capacitor has a predetermined maximum capacitance, and may be charged to its maximum capacity, but typically it is initially charge to a capacitance less than its maximum. Whatever is the capacitor's initial charge, after disconnection from the coil and discharged, most of the electrical energy is returned to the coil; however, there are energy losses, mainly due to the construction of the capacitor. Moreover, not all the energy is drained from the capacitor. To make up for these losses, additional energy from the power supply is provided upon reconnection of the capacitor to the coil. Optionally, a quick charge and discharge battery may be included in the control circuit into which any residual energy stored in the capacitor or capacitors is drained. The capacitor may be recharged to the same or a different level as its initial charge, but ideally it is recharged to a level substantially equal to its initial charge.

Four, the switching and timing control circuit synchronizes the operation of the control circuit to allow electric current to circulate through the coil for a predetermined period of time in the controlled manner as discussed above to regulate timing to make up for substantially all the energy losses.

Five, the control circuit generates a pulse of electrical energy that is periodically applied to the coil with the capacitor isolated from the coil. This pulse of electrical energy includes sufficient make up energy substantially equal to energy losses due to the capacitor.

Six, the combination of a mechanical drive and my engine provides a new system for transferring energy wherein a pulse of electrical energy through the coil creates a magnetic field that produces a magnetic coupling that intermittently couples to the mechanical drive as a series of pulses are applied to the coil. The control circuit provides a means for generating the series of pulses as the capacitor is charged and discharged where essentially each pulse in the series includes make up energy due to capacitor losses.

These features are not listed in any rank order nor is this list intended to be exhaustive.

### DESCRIPTION OF THE DRAWING

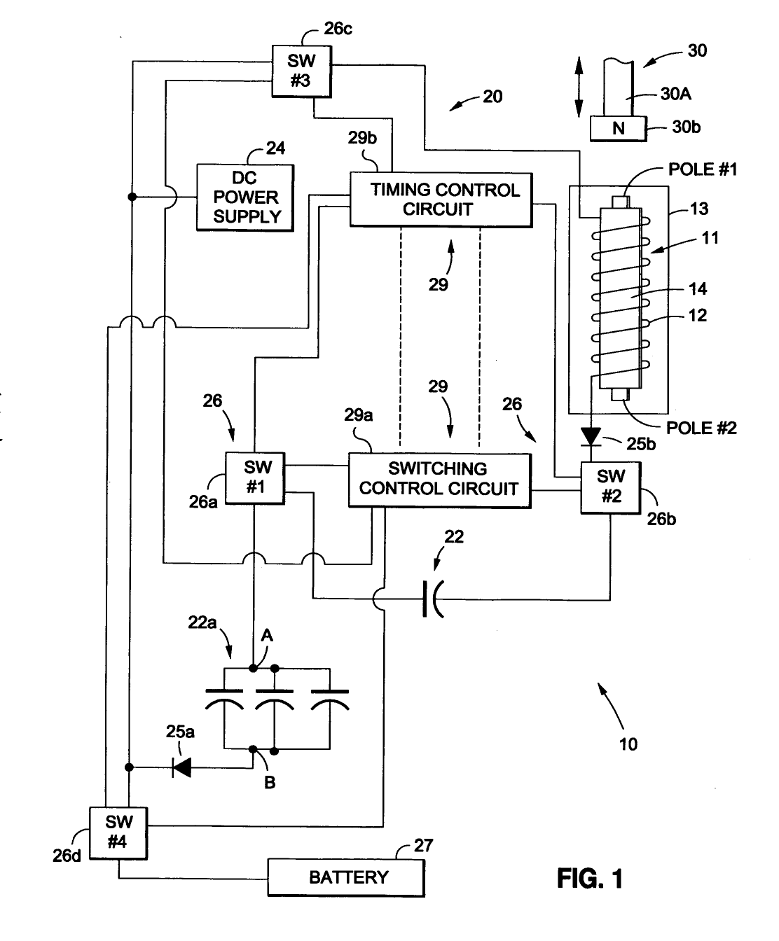

Some embodiments of my phase change pulse engine are discussed in detail in connection with the accompanying drawing, which is for illustrative purposes only. This drawing includes FIG. 1, which is a schematic diagram depicting one embodiment of my phase change pulse engine.

### DETAILED DESCRIPTION OF SOME ILLUSTRATIVE EMBODIMENTS

As shown in FIG. 1, one embodiment of my phase change pulse engine is designated by numeral 10. This embodiment includes a super-conducting magnet 11 including a coil 12 and a core 14 capable of being magnetized and de-magnetized and an electrical control circuit 20. The core 14 has opposed poles #1 and #2. The intensity of the magnetic field at each pole #1 and #2 may be increased or decreased or the polarities thereof may be reversed. A series of intermittent pulses of electricity flows through the magnet 11, creating in the magnet 11 a magnetic coupling that actuates a mechanical drive 30. The magnet 11 in my engine 10 may be cooled by many different liquids, for example, liquid nitrogen 77 degrees Kelvin and helium 4 degrees Kelvin. The cooling agent depends on the material used in the wiring (or conductive metal, in the case of using rail-gun or other configuration to harness the electromagnetic force). My engine's electric consumption is minimized because of the pulsing and switching/timing control of current flow in my engine.

The super-conducting magnet 11 is within a container 13 holding a coolant that super cools the coil 12 to a temperature of less than, for example, 135 degrees Kelvin. In my engine 10 a magnetic field is initially created, collapsed at least partially, and re-created through the firing of a capacitor 22 in the electrical circuit 20. This capacitor 22 has a predetermined capacitance and is capable of being repeatedly fired to produce a pulse of current. The pulse of electric current flows through the coil 12 to create a magnetic field that produces the magnetic coupling. The flow of current is controlled switching and timing control circuit 29 having interactive, coupled together switching sub-circuit 29a and timing sub-circuit 29b. After the initial pulse of current is introduced into the coil 12, the switching sub-circuit 29a operating a switch mechanism 26 disconnects the coil 12 and capacitor 22. After a very short predetermined time period, the timing sub-circuit 29b re-establishes a connection between the coil 12 and capacitor 22. The switch mechanism 26 includes four switches 26a, 26b, 26c, and 26d.

For example, discontinuing (or reversing the direction of) current flow through the coil 12 produces a changing magnetic field that creates the driving force of my engine 10 to power the mechanical drive 30. The mechanical drive 30 includes an element that is interactive with the changing magnetic field to produce motion as the magnetic field fluctuates. For example, the changing magnetic field may drive a rod 30a with a magnet at the rod's end positioned with its north pole 30b next to the pole #1 of the magnet 11. For example, the rod 30a is pulled toward the pole #1 of the magnet 11 when the current flows in one direction and is repelled when the current reverses direction. Alternately, the interactive element of the mechanical drive 30 may be a continuous rotational device such as a rotor in an electric motor or dynamo.

The electrical circuit 20 includes a power supply 24, for example, a DC power supply, the capacitor 22, connected to the power supply under the control of the switching sub-circuit 29a and the timing sub-circuit 29b. The switching sub-circuit 29a operates the switches 26a and 26b, opening one while closing the other, and operates switches 26c and 26d, opening or closing both essentially at the same instant. The timing sub-circuit 29b interacting with the switching sub-circuit 29a governs the flow of current between the coil 12 and the capacitor 22 also by controlling the operation of the switches 26a, 26b, 26c, and 26d. There is a plurality of auxiliary capacitors 22a connected in parallel. These auxiliary capacitors 22a have their input terminal A connected to the switch 26a and their output terminal connected to the switch 26d through a diode 25a. The switch 26b is connected to the coil 12 via a diode 25b. The diodes 25a and 25b control the direction of current flow so it is only in one direction, from the coil 12 into the capacitors 22 and 22a. With each pulse of current into the coil 12 from the capacitor 22, a connection between the coil 12 and capacitor 22 is broken and re-established, collapsing the magnet field, for example by reversing the direction of flow of electric current through the coil 12 to change the polarity of the pole #1 of the magnet 11. The auxiliary capacitors 22a into which the capacitor 22 is discharged may be connected to a quick charge and discharge battery 27. There may be a residual charge in the capacitors 22 and 22a. This residual charge is drained to avoid saturation upon connection to the battery 27 after discharging the capacitors.

The capacitor 22 is initially charged and then the timing circuit causes the configuration of the switches 26a, 26b, 26c, 26d to be altered, discharging a pulse of electric current through the coil 12 to create a fluctuating magnet field. There is essentially no energy loss in the magnet 11 due to its superconductivity. At the precise moment in the operation of my engine 10, the timing sub-circuit 29b and switching sub-circuit 29a acting in concert, disconnects the coil and capacitor, enabling current to flow the capacitor 22 and applied to the coil, which has been reconnected to the capacitor through the now closed switch 26b to recharge the previously discharged capacitor. Normally, there are some losses so the capacitor 22 is only recharged to less than its initial capacitance upon redirecting the discharge of electricity into the coil. Under the control of the timing sub-circuit 29b, the power supply 24 through the switch 26c then applies additional current to the capacitor 22 via the coil 12. This charging and discharging (or firing) of the capacitor 22 is continually repeated under the control of the switching and timing control circuit 29. In another embodiment, the polarity of the magnet 11 may remain constant but the intensity of its magnetic field is increased and decreased.

There are three components which may be used separately or together to manipulate the electric flow and magnetic variance, or pulse.

1. The capacitor 22 may be used to pulse the electron flow, so that a discreet amount of electricity is sent through the superconducting magnet 11. For example, so that it is approximately equal or less than or greater than the initial charge on the capacitor 22. When the electricity reenters the capacitor 22, it stops because it looses energy in resistance and storage—then just enough electrical energy is added to the engine 10 (for example beyond its initial charge) and it discharges. This cycles and goes over and over again, essentially just loosing energy when entering the capacitor. There are other scenarios able to cause this cycling, introducing far less electrons and then add enough electrons to have a capacitor fire. Or, have a little or much greater electrons and then a resistor before or after a capacitor, so that the capacitor doesn't discharge unless there is an introduction of more electrons.

2. Pulsing—or oscillating crystal—or other form of switching control circuit, for example, a diode that turns on and off the current.

3. An electronic or physical switch that reroutes the circuitry (actually trips a switch so that the electricity is rerouted to another circuit so that the initial superconducting magnetic coil looses energy for a short time and this energy is channeled to a another circuit). A switch could route the electrons to another coil that is wrapped around the same superconducting magnet 11. This coil or wire would be wrapped in the opposite direction to achieve a reverse field. The switching would go back and forth so as to achieve a change in magnetic field that would best propel a dynamo around or piston up and down. The electricity could also be stored in a capacitor or other storage device and then a switch in the circuit could switch to the other side of the same coil and run the electrons in the reverse direction, causing a reverse magnet field. The switch would switch back and forth creating alternate magnetic fields, and the speed of the alternation would be set specifically for best performance of my engine 10.

Naturally within anyone engine there may be several of these superconducting magnets arrayed in a circular pattern in one area or several areas. These individual units discussed may be arranged in any multiple and any pattern that facilitates the operation of the electrical engine. Rare earth magnets or any sufficiently powerful magnet may be used in conjunction with the super cooled magnetic field, either as a turbine or with outer magnets that flank the turbine or a piston or a magnetic plate that the piston is attracted to or repelled from or both. The three separate methods mentioned above maybe combined altogether or any two to effect magnetic field changes. My phase change pulse engine may use either LTS (low temperature superconductors) or HTS (high temperature superconductors). Note: Low temperature superconductor electrons continues to flow as long as the conducting material is kept at superconducting temperature and/or critical magnet field strength is not reached. High temperature superconductors once the magnets have reached sufficient charge, require low voltage and high amps to produce a strong magnet field. The original charging of the superconducting requires more electricity to start the superconducting magnet to strong field strength than to maintain that field. Both LTS and HTS superconductors allow the electrons to go unimpeded or relatively unimpeded, so that this energy can be collected and re-released with a large amount of the original energy available. This is also true in switching where the energy is temporarily diverted, or shared between two or more separate superconducting electromagnet systems, or as mentioned, the same system but rerouted in different direction in an alternating fashion. Note: Unlike a regular electro-magnetic system where the electrons are slowed or sped up by an introduction of an exterior magnetic field, this does not happen until a critical level of magnetic field is introduced into the superconducting electro-magnetic system.

The methods described above create a magnetic field flux, so that motion will occur with the moving parts of the mechanical drive, and because of the superconducting nature of the material, wire or rail gun like configuration with a piston-like projectile, or other shapes, the flow of electrons are pulsed and the magnetic field is interrupted.

My engine 10 may be used for cars, but may be harnessed for any other vehicle needing this type of power plant, for example, a train, boat, plane.

### SCOPE OF THE INVENTION

The above presents a description of the best mode I contemplate of carrying out my phase change pulse engine, and of the manner and process of making and using it, in such full, clear, concise, and exact terms as to enable a person skilled in the art to make and use. My phase change pulse engine is, however, susceptible to modifications and alternate constructions from the illustrative embodiment discussed above which are fully equivalent. Consequently, it is not the intention to limit my phase change pulse engine to the particular embodiment disclosed. On the contrary, my intention is to cover all modifications and alternate constructions coming within the spirit and scope of my phase change pulse engine as generally expressed by the following claims, which particularly point out and distinctly claim the subject matter of my invention:

1. An engine comprising
a capacitor,
a power supply,
a superconducting magnet including a coil and a core capable of being magnetized, so that a flow of electric current through the coil creates a magnetic field that produces a magnetic coupling for a mechanical drive, and
a control circuit connecting the capacitor, the coil, and the power supply, and including a switching and timing control circuit that periodically applies to the coil a pulse of electrical energy by a discharge of the capacitor,
said pulse of electrical energy including make up energy due to capacitor losses.

2. The engine of claim 1 where the switching and timing control circuit that charges the coil, then isolates the coil from the capacitor, and then reconnects the coil and capacitor to generate the pulse of electrical energy.

3. The phase change pulse engine of claim 1 where the switching and timing control circuit changes the direction of flow of electric current through the coil and reverses the polarity of the magnet.

4. The phase change pulse engine of claim 3 where the switching and timing control circuit synchronizes the operation of the switching control circuit to allow the current to circulate through the coil for a predetermined period of time.

5. The phase change pulse engine of claim 1 where the polarity of the magnet remains constant but the intensity of its magnetic field increases and decreases.

6. The phase change pulse engine of claim 1 where the power supply is a DC power supply.

7. An engine comprising
a first capacitor,
a power supply,
a superconducting magnet including a coil and a core capable of being magnetized, so that a flow of electric current through the coil creates a magnetic field that produces a magnetic coupling for a mechanical drive, and
a control circuit connecting the capacitor, the coil, and the power supply, and including a switching and timing control circuit,
said switching and timing control circuit governing the interaction between the capacitor coil, and power supply and having (a) a first state where current flows through the coil and into the capacitor, (b) a second state where the capacitor is disconnected from the coil, and (c) a third state where the capacitor is reconnected to the coil and current again flows through the coil and again into the capacitor.

8. The phase change pulse engine of claim 7 including an auxiliary capacitor into which said first capacitor is discharged.

9. The phase change pulse engine of claim 7 including a quick charge and discharge battery into which residual charge from the first capacitor is drained to avoid saturation of said first capacitor.

10. The phase change pulse engine of claim 9 including an auxiliary capacitor into which said first capacitor is discharged, said auxiliary capacitor being connected to the quick charge and discharge battery into which residual charge from the auxiliary capacitor is drained to avoid saturation of said auxiliary capacitor.

11. The phase change pulse engine of claim 7 where the flow of current is a pulse of electrical energy, said pulse of electrical energy including make up energy due to capacitor losses.

12. The combination of a mechanical drive and an engine, said engine comprising
a superconducting magnet including a coil and a core capable of being magnetized, so that a pulse of electrical energy through the coil creates a magnetic field that produces a magnetic coupling that intermittently couples to the mechanical drive as a series of pulses are applied to the coil, and
means for generating the series of pulses including a capacitor that is charged and discharged to produce a pulse, essentially each pulse in the series including make up energy due to capacitor losses.
